(19) United States
(12) Patent Application Publication
(10) Pub. No.: US 2006/0291825 A1
(43) Pub. Date: Dec. 28, 2006

(54) Arrangement for vaporizing materials

(76) Inventors: Stefan Hein, Blankenbach (DE); Gunter Klemm, Nidda (DE); Peter Skuk, Niderau (DE)

Correspondence Address: FULBRIGHT & JAWORSKI, LLP, 666 FIFTH AVE, NEW YORK, NY, 10103-3198, US

(21) Appl. No.: 11/012,083

(22) Filed: Dec. 13, 2004

(30) Foreign Application Priority Data
Nov. 20, 2004 (EP) 04 027 616.4

(51) Int. Cl. A61H 33/06; F22B 1/28; B01D 1/00; B01D 3/00; B05B 1/24; F24F 6/00

(52) U.S. Cl. 392/394

(57) ABSTRACT

The invention relates to an arrangement for vaporizing materials with a vaporizer crucible, in which is disposed the material to be vaporized. About the vaporizer crucible is placed a vaporizer tube, which, seen in the longitudinal direction of the vaporizer tube, comprises at least two heating circuits, spatially disposed one after the other and electrically controllable separately. Each of these heating circuits comprises at least two heating subcircuits, of which on is disposed on one side of the vaporizer tube and one on the other side of the vaporizer tube. The vaporizer tube is provided with a top portion which has its own heating circuit.

The invention relates to an arrangement according to the preamble of patent claim 1.

In vacuum coating technology vaporizers are required in order to vaporize materials, for example metals, and to provide substrates with a material coating. The substrates can involve films, webs and the like (cf. DE 195 27 604 A1, DE 43 10 085 A1, DE 42 23 568 C1, DE 42 03 632 C2, DE 102 24 908 A1). As a rule, the vaporizer comprises a vaporization crucible containing the material to be vaporized. Above the vaporizer crucible can be provided a nozzle bar formed of a metal profile slotted in the longitudinal direction. The nozzle opening formed by the slot ensures that the vaporized material emanating from the vaporizer crucible is uniformly deposited onto the substrate located directly in front of the nozzle opening. The heating elements are here heating coils (DE 38 17 513 C2). As the heating element for heating the material in a vaporizer boat or crucible, it is also possible to utilize a graphite foil provided with slots, which form a meander band about the crucible (WO 00/46418).

In another vapor deposition arrangement for vacuum vaporization installations an electric heating rod is provided as the heating element (DE 198 43 818 A1).

A high vacuum coating installation is furthermore known, in which material is vaporized by means of high current and, for the generation of the high current, at least one transformer with an iron core, a primary winding and a secondary winding is provided, whose secondary winding is connected to the material to be vaporized or to the crucible to be heated (DE 42 09 334 C2, U.S. Pat. No. 2,664,853).

Lastly, an arrangement is also known for regulating the vaporizer rate of crucibles, which are heated by current throughflow and from which metal is vaporized (DE 44 04 550 C2). In this arrangement the total resistance composed of the electric resistance of a crucible and the electric resistance of the metal, disposed in the crucible and to be vaporized, is regulated to a specific value.

Most of the known vaporizers have only one heating circuit leading to poor regulatability of the vaporizer performance. In addition, as an expendable part the nozzle bar is deformed during operation, which necessitates a predeformation with each exchange of the nozzle bar.

The object of the invention is to increase the regulatability of the vaporizer performance.

This object is attained according to the characteristics of claim 1.

The invention consequently relates to an arrangement for vaporizing materials with a vaporizer crucible, in which is disposed the material to be vaporized. About the vaporizer crucible is placed a vaporizer tube, which—viewed in the longitudinal direction of the vaporizer tube—comprises at least two heating circuits, spatially disposed one behind the other, which can be electrically controlled separately from one another, each of these heating circuits comprising at least two heating subcircuits, one of which is disposed on one side of the vaporizer tube and one on the other side of the vaporizer tube. The vaporizer tube is provided with a top portion, which has its own heating circuit.

The advantage attained with the invention comprises that the nozzle bar is substantially less prone to failure and the exchange of the nozzle bar is simplified. The vaporizer tube is additionally heated more uniformly in its longitudinal direction. The vaporizer performance is furthermore well regulatable and the current-carrying heating coils do not form undesirable plasmas.

An embodiment example of the invention is depicted in the drawing and be described in the following in further detail. In the drawing depict:

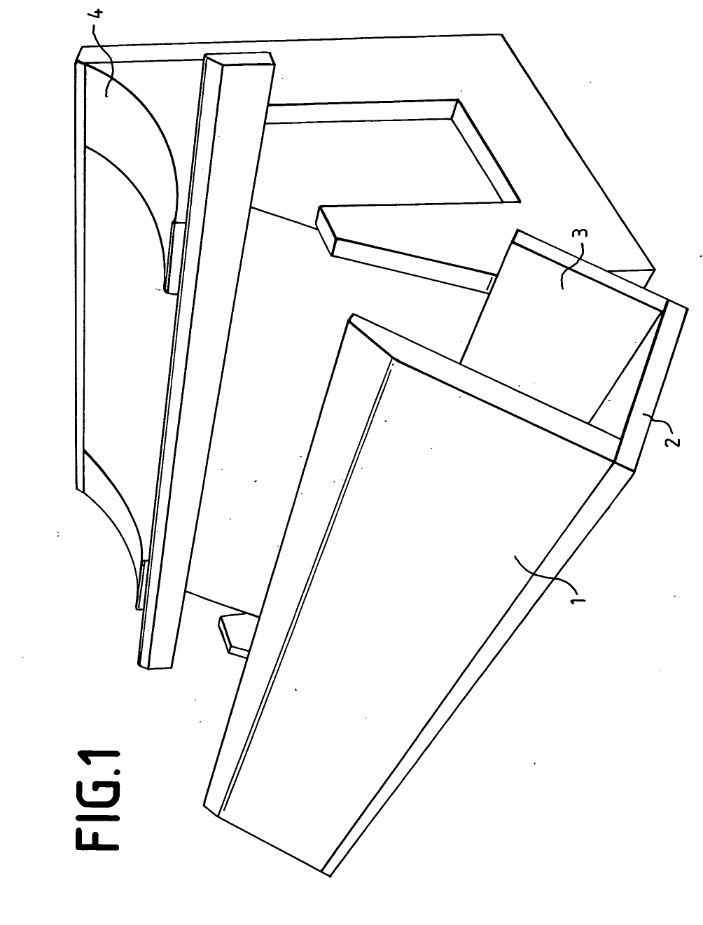

FIG. 1 a portion of a web coating installation for seating a vaporizer,

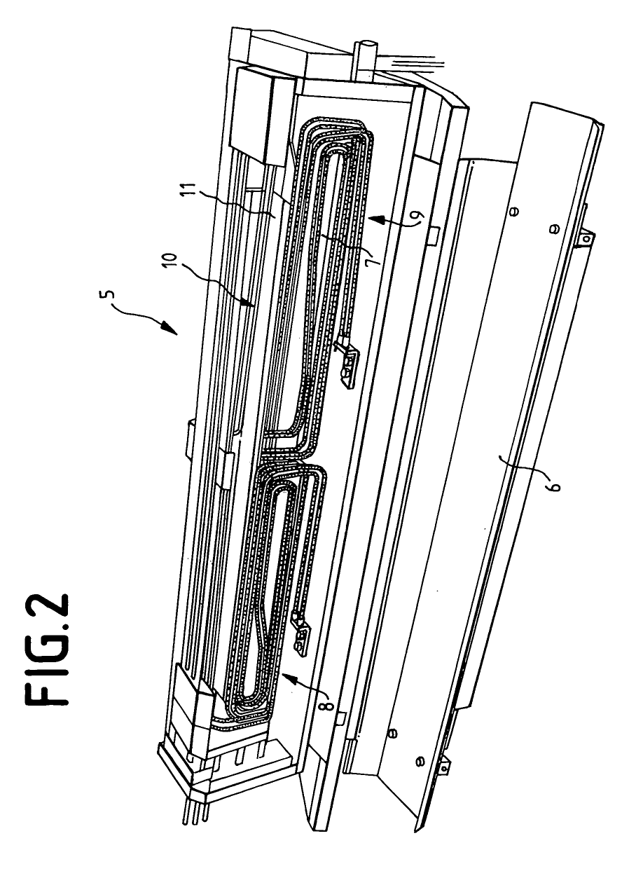

FIG. 2 a perspective view of a partially open vaporizer,

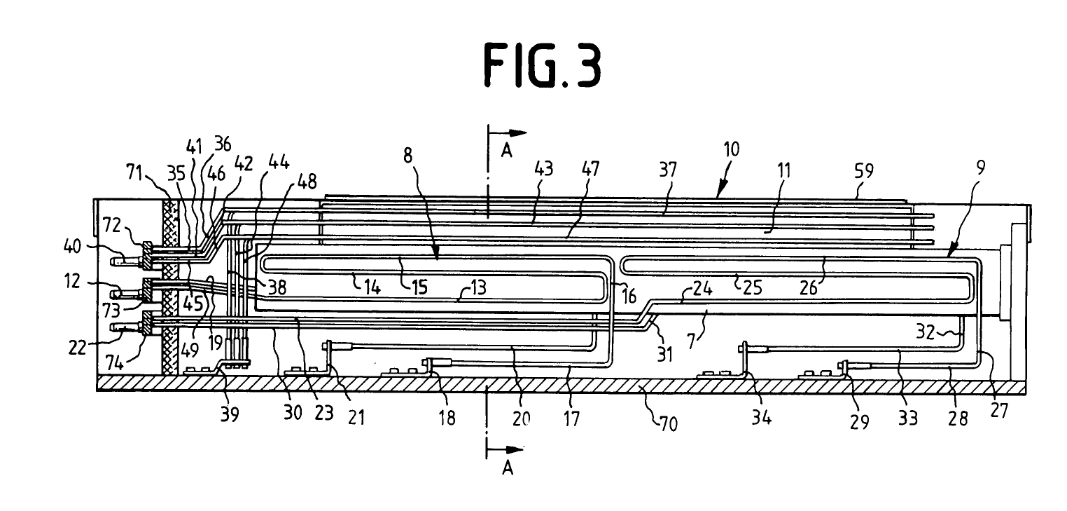

FIG. 3 an illustration of three heating subcircuits on one side of a vaporizer,

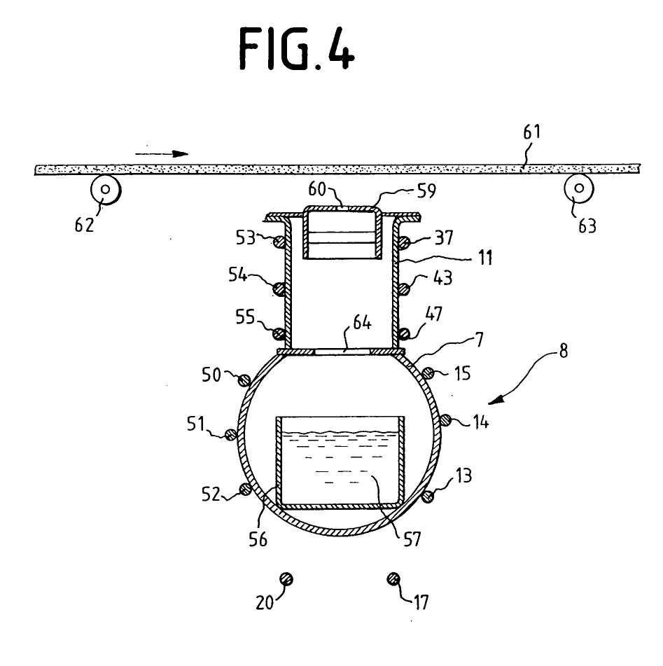

FIG. 4 a cross section through the vaporizer according to FIG. 3.

In FIG. 1 is depicted a portion of a web coating installation. This portion comprises a seating for a vaporizer, which is formed by three walls 1, 2, 3. The walls 1 and 3 extend parallel, while the wall 2 forms a bottom. Above the seating with the three walls 1, 2, 3 is disposed a part 4 over which, during operation of the installation, runs a cylinder guiding a web or a film. The surface of part 4 is therefore implemented arcuate in adaptation to the, not shown, cylinder.

Between walls 1, 3, and resting on the bottom, a vaporizer 5 is introduced, which is not further shown in FIG. 2.

In this vaporizer 5 shown in FIG. 2 a side covering 6 is folded away, such that one side of the vaporizer tube 7 is exposed. It is evident that the exposed side of the vaporizer tube 7 comprises two heating subcircuits 8, 9. To these heating subcircuits correspond on the opposite side of the vaporizer tube 7 two further heating subcircuits, which are not visible in FIG. 2. Heating subcircuit 8 forms with the nonvisible heating subcircuit on the opposite side of the vaporizer tube 7 a first heating circuit, while heating subcircuit 9 forms a second heating circuit with the opposite hidden heating subcircuit. The heating subcircuits of a heating circuit are electrically connected in parallel. A heating subcircuit can, in turn, be comprised of one or more heating conducting leads. Each of the heating subcircuits 8, 9 depicted in FIG. 2 has two heating conducting leads.

A third heating circuit 10 is located at the top portion 11 of vaporizer tube 7.

Further details of the disposition of the heating conductors are evident in the simplified illustration of FIG. 3.

In this FIG. 3 can be seen the front heating subcircuit 8 and the rear heating subcircuit 9. In contrast to FIG. 2, each of the heating subcircuits 8, 9, for the sake of clarity, comprises only one heating conducting lead. A heating conductor 49 starts at a plug terminal 12 and leads via the heating conductor segments 13 to 17 to a connection to ground 18.

The essentially not visible heating conductor 19 disposed on the opposite side, also starts at plug terminal 12 and is subsequently hidden behind the vaporizer tube 7. This heating conductor subsequently becomes visible again as heating conductor segment 20 and terminates at ground connection 21. Therewith the first heating circuit becomes a closed circuit.

The second heating circuit is comprised of the rear heating subcircuit 9 and the substantially not visible heating subcircuit on the other side of the vaporizer tube 7. The heating subcircuit 9 starts at a plug terminal 22 and leads via heating conductor segments 23 to 28 to a ground connection 29. The substantially not visible heating subcircuit also starts at plug terminal 22 and leads via heating conductor segments 30, 31 behind the vaporizer tube 7 and subsequently becomes visible again as heating conductor segments 32, 33 and leads to a ground connection 34.

The third heating circuit 10 is located at the top portion 11 of the vaporizer tube 7. It comprises a first heating conductor with the heating conductor segments 35 to 37, connected to a plug terminal 40, and parallel to the heating conductor segment 37 and behind the top portion 11 a return heating conductor segment is provided, which is connected with a ground connection 39 via the heating conductor segment 38.

Connected to the same plug terminal 40 is a second heating conductor with the heating conductor segments 41 to 43 and with a return heating conductor segment, not visible behind the top portion 11, which is connected via the heating conductor segment 44 with the ground connection 39.

A third heating conductor, a component of heating circuit 10, is also connected to plug terminal 40 and leads via its heating conductor segments 45 to 48 to ground connection 39. The heating conductor segment 48 is here a portion of a heating conductor segment extending behind the top portion 11. By 72, 73, 74 are denoted terminal strips, while 70 denotes a base plate and 71 are insulation plates.

All three heating conductors forming the heating circuit 10 are electrically connected in parallel.

As described earlier, the heating subcircuits shown in FIG. 2 comprise twice as many heating conductors as the heating subcircuits according to FIG. 3.

In FIG. 4 is shown an enlarged section A-A through the vaporizer tube 7 and the top portion 11 according to FIG. 3. Evident are here the heating conductor segments 15, 14, 13 and 17, 50 to 52 and 20 of the first heating circuit.

The heating conductor segments 37, 43, 47, 53 to 55 form the third heating circuit. Between the heating conductor segments 53 and 37 is disposed a nozzle bar 59 with a nozzle 60. Through this nozzle 60 the vaporized material is delivered onto a web 61 to be coated, which is guided via rollers 62, 63.

The second heating circuit is not visible in FIG. 4.

In the vaporizer tube 7 is located a crucible, in which is disposed a material 57 to be vaporized.

In the upper region of the vaporizer tube 7 is provided a longitudinal slot 64.

The vaporizer tube 7 and the top portion 11 can be encompassed by laminated insulation sheet in order to bring about thermal insulation.

The coating of the web 61 takes place such that the material 57 in crucible 56 disposed in vaporizer tube 7 is heated such that it vaporizes and through the slot 64 and nozzle 60 reaches web 61.

Consequently, the invention provides three or more regulatable heating circuits. One heating circuit ensures the desired temperature of the nozzle bar, which is independent of the temperature of the vaporizer tube. At least two further regulatable heating circuits are provided for the longitudinal distribution of the temperature in the vaporizer tube.

The heating conductors utilized are so-called jacket heating conductors, which are comprised of an electrically well conducting core, an insulation layer encompassing the latter, and a metal shell encompassing the insulation layer. The individual heating circuits are comprised of several heating conductors.

1. An arrangement for vaporizing materials, with a vaporizer crucible in which is disposed a material to be vaporized, wherein
a vaporizer tube, encompassing the vaporizer crucible, which is comprised of at least two heating circuits, one spatially disposed after the other, and electrically controllable separately.

2. The arrangement as claimed in claim 1, wherein each heating circuit is comprised of at least two heating subcircuits opposite to one another with respect to the vaporizer tube.

3. The arrangement as claimed in claim 1, wherein the vaporizer tube is provided with a top portion which comprises its own heating circuit.

4. The arrangement as claimed in claim 1, wherein the vaporizer tube has an opening above the level of the material to be vaporized.

5. The arrangement as claimed in claim 3, wherein in the upper region of the top portion a nozzle bar with a slot is provided.

6. The arrangement as claimed in claim 2, wherein the heating subcircuits comprise heating conductors, which are disposed in the form of a meander on the outside of the vaporizer tube.

7. The arrangement as claimed in claim 3, wherein the heating circuit of the top portion comprises several heating conductors extending on one side of the top portion, subsequently bend around on the other side of the top portion and return as heating conductors on this other side of the top portion.

8. The arrangement as claimed in claim 1, wherein above the vaporizer tube a web is provided which runs over rollers.

9. The arrangement as claimed in claim 1, wherein the nozzle bar is disposed between the web and the opening of the vaporizer tube.
